(19) United States
(12) Patent Application Publication
(10) Pub. No.: US 2026/0062329 A1
(43) Pub. Date: Mar. 5, 2026

(54) DUAL STEM SLIDE GATE HAVING IMPROVED SEAL

(71) Applicant: PB Equipment Inc., Georgetown, TX (US)

(72) Inventor: Derek Michael SHIRES, Bartlett, TX (US)

(21) Appl. No.: 19/314,692

(22) Filed: Aug. 29, 2025

Related U.S. Application Data
(60) Provisional application No. 63/688,334, filed on Aug. 29, 2024.

(51) Int. Cl. C02F 3/12

(52) U.S. Cl. CPC C02F 3/1268; C02F 2203/006; C02F 2209/40; C02F 2301/08

(57) ABSTRACT

A slide gate assembly and related system and method for controlling flow in a wastewater treatment facility are disclosed. The slide gate assembly includes a gate slide positioned within a wall frame and configured to move vertically between open and closed positions. A pair of stems are mounted at opposite lateral sides of the gate slide and extend into an actuator frame for coordinated actuation. A gasket seal having a batwing profile with vulcanized mitered corners is mounted between the gate slide and the wall frame to provide multiple sealing contact points and reduce leakage. The wastewater treatment facility incorporates the slide gate assembly into channels connecting treatment stages, including a buffer tank, a screening unit, a pre-treatment tank, an aeration tank, and a membrane bioreactor basin. A method of controlling wastewater flow includes actuating the dual stems to raise or lower the gate slide and sealing the slide against the wall frame.

### CROSS-REFERENCE TO RELATED APPLICATIONS

This application claims the benefit of U.S. Provisional Application Ser. No. 63/688,334, filed Aug. 29, 2024, and entitled “DUAL STEM SLIDE GATE HAVING IMPROVED SEAL,” which is hereby incorporated by reference for all purposes.

### BACKGROUND

Slide gates are commonly employed in water and wastewater treatment facilities to regulate fluid flow between treatment stages. These gates are typically installed in channels or conduits and are configured to move between open and closed positions to control water level, flow rate, or isolation of equipment. Conventional slide gate designs may be operated manually, mechanically, or with powered actuators, and are often constructed to accommodate seated head, unseated head, or both. The gates are widely used in municipal, industrial, and agricultural systems to maintain controlled hydraulic conditions throughout treatment processes.

In many established designs, a single central stem is used to actuate a vertically mounted gate. While this configuration can provide straightforward operation, it presents challenges in environments where floating debris, scum, or solids are present in the fluid stream. Material carried by wastewater may accumulate around the centrally positioned stem, interfering with gate actuation. In addition, continuous exposure of the stem to fouling can result in increased maintenance demands, interruptions to system operation, and higher operating costs for treatment facilities.

Sealing performance of slide gates also represents a technical challenge in the field. Flat gasket arrangements or single-line contact seals often provide incomplete sealing under variable hydraulic pressure conditions. Leakage through imperfect seals can reduce the efficiency of treatment processes, introduce unwanted bypass flow, and contribute to downstream contamination. Corner regions of sealing interfaces are particularly susceptible to leakage, as conventional seals may not maintain uniform compression across the entire perimeter of the gate. As a result, both fouling of actuation mechanisms and limitations in seal design remain significant considerations in the design and operation of slide gates used in water and wastewater treatment applications.

### SUMMARY

The disclosed apparatus is directed to a slide gate assembly configured for regulating flow within a wastewater treatment system. The assembly includes a gate slide mounted within a wall frame and arranged to move vertically between open and closed positions. A pair of stems are positioned at opposite lateral sides of the gate slide and extend upward into an actuator frame, where they are driven by actuators through shafts, sprockets, and related components. A gasket seal with a batwing profile is mounted between the gate slide and the wall frame. The batwing profile includes multiple contact extensions and vulcanized mitered corners that form a continuous watertight barrier, reducing leakage and improving sealing performance under varying hydraulic pressures.

In another embodiment, the invention is directed to a wastewater treatment facility incorporating the slide gate assembly into channels connecting treatment stages. The facility includes a buffer tank, screening unit, pre-treatment tank, aeration tank, and membrane bioreactor basin arranged in sequence. The slide gate assembly is disposed within one or more of the connecting channels to regulate flow between the tanks. By positioning stems at opposite lateral sides of the gate slide, the gate assembly avoids vertical obstructions in the flow path, thereby reducing fouling from floating debris. The batwing gasket seal maintains engagement along the entire perimeter of the gate slide, minimizing leakage and enabling precise control of flow between treatment stages.

A further embodiment is directed to a method for controlling flow of wastewater between treatment stages in the facility. The method includes providing a slide gate assembly comprising a gate slide, dual stems, an actuator frame, and a batwing gasket seal. The stems are actuated through actuators and mechanical linkages to raise or lower the gate slide between open and closed positions. As the gate slide engages with the wall frame, the batwing gasket seal compresses to form multiple contact points with the gate slide and wall frame, establishing a continuous sealing barrier. The method permits regulation of wastewater flow through the treatment process while maintaining consistent sealing performance and reducing maintenance demands associated with fouling.

Other aspects of the one or more embodiments will be apparent from the following description and the appended claims.

### BRIEF DESCRIPTION OF DRAWINGS

FIG. 1 shows a wastewater treatment system, in accordance with one or more illustrative embodiments.

FIG. 2 shows a slide gate assembly, in accordance with one or more illustrative embodiments.

FIG. 3 shows a cutaway view of the slide gate assembly, in accordance with one or more illustrative embodiments.

FIG. 4 shows a top view of the actuator frame, in accordance with one or more illustrative embodiments.

FIG. 5 shows a detail view of actuator 320a, in accordance with one or more illustrative embodiments.

FIG. 6 shows a detail view of actuator 320b, in accordance with one or more illustrative embodiments.

FIG. 7 shows a detail view of the gate slide and actuator rod attachment, in accordance with one or more illustrative embodiments.

FIG. 8 shows a detail view of the wall frame with attached gasket seal, in accordance with one or more illustrative embodiments.

FIG. 9 shows a cross-section view of the wall frame illustrating the batwing profile of the gasket seal, in accordance with one or more illustrative embodiments.

FIG. 10 shows a flowchart of a process for controlling flow of wastewater between treatment stages in a wastewater treatment facility, in accordance with one or more illustrative embodiments.

### DETAILED DESCRIPTION

In general, the one or more embodiments relate to water treatment devices, systems, and methods. In particular, the one or more embodiments are directed to a dual stem slide gate having improved seal.

The disclosed slide gate assembly introduces a dual stem configuration that departs from traditional single-stem arrangements. By positioning the stems at opposite lateral sides of the gate slide rather than at the center, the flow path remains unobstructed by vertical members. This structural change reduces the likelihood of fouling caused by scum, floating debris, or suspended solids that accumulate around centrally located stems. The dual stem arrangement distributes actuation forces evenly across the gate slide, resulting in balanced movement and reduced stress concentrations within the frame.

The sealing system of the assembly incorporates a gasket with a batwing profile mounted along the wall frame. The batwing gasket provides multiple contact surfaces between the gate slide and the wall frame. The gasket is constructed from elastomeric materials suitable for wastewater environments and includes mitered corners that are vulcanized to form a continuous watertight barrier. This design improves sealing performance across the full perimeter of the gate slide, including corner regions that are typically prone to leakage. The gasket is retained in position with a gasket hold and reinforced by a track stiffener that maintains frame rigidity under hydraulic loading.

Integration of the actuation system with the dual stems further supports reliable operation. Actuators mounted to the actuator frame transfer motion through drive shafts, sprockets, and drive screws to pistons contained within actuator tubes. Linear motion is transmitted to actuator rods coupled directly to the gate slide, producing synchronized vertical displacement across both stems. Low-friction bushings and slide guides align the gate slide with the wall frame and gasket seal during movement, ensuring consistent sealing engagement. Together, these features address fouling of actuation mechanisms and limitations in sealing efficiency observed in prior designs.

Specific embodiments will now be described in detail with reference to the accompanying figures. Like elements in the various figures are denoted by like reference numerals for consistency.

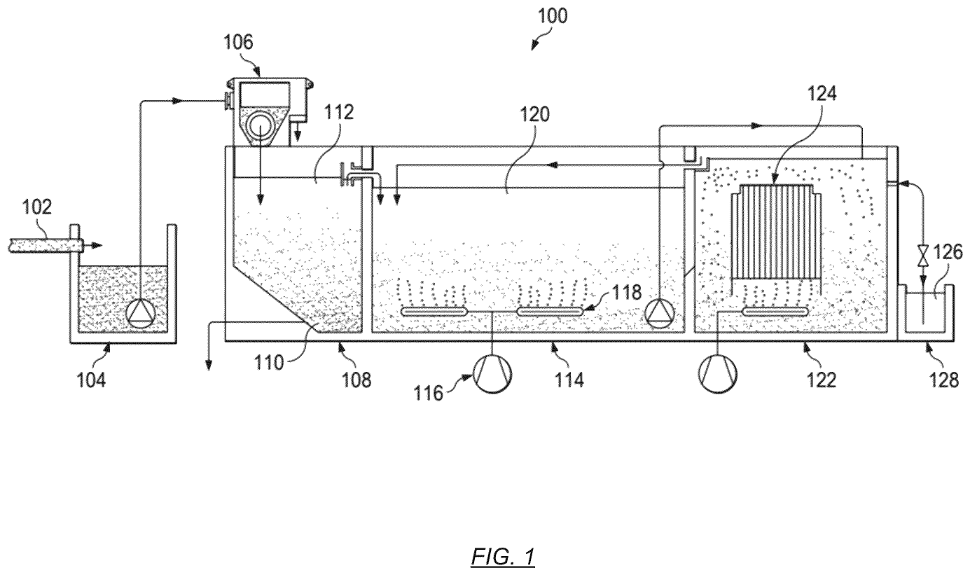

Attention is now turned to the figures. FIG. 1 shows a wastewater treatment system (100), in accordance with one or more embodiments. The wastewater treatment system (100) is used to filter wastewater (e.g., sewage or mixed liquor) so that the contaminants may be discarded, and the treated water discharged or recycled. The wastewater treatment system (100) shown in FIG. 1 is only an exemplary system. Many diverse types of water and wastewater treatment systems exist, and any particular water treatment system may have more or fewer treatment stages or unit processes.

In the example of FIG. 1, wastewater (102) (e.g., raw sewage) is pumped into a buffer tank (104). Use of the buffer tank (104) allows the water treatment system (100) to control the rate at which the wastewater (102) is pumped into the remaining stages of the wastewater treatment system (100).

The wastewater (102) is then pumped into a screening unit (106). The screening unit (106) may take many different forms, such as but not limited to one or more screens, conveyors, etc. The screening unit (106) removes large objects (stones, lost jewelry, sticks, bones, etc.) that may have entered with the wastewater (102). The large objects are collected and discarded properly.

Additionally, heavier particulates, but which are too small to be removed by the screening unit (106), may settle in the bottom of a pre-treatment tank (108) in the form of sludge (110). The sludge (110) may be pumped from the pre-treatment tank (108), possibly further treated, and then discarded properly.

Next, remaining wastewater (112) is pumped or flows via gravity to an aeration tank (114). The aeration tank (114) is connected to a gas line (116) that feeds gas (e.g., air or oxygen) to one or more diffusers (118). The diffusers (118) force the gas into the water. The gas forms bubbles which rise to the surface of the water in the aeration tank (114). In this manner, the remaining wastewater (112) becomes aerated water (120). Aeration reduces the amount of organic matter and microorganisms, increases oxygen content for future biological processing, speeds organic decomposition, and induces other useful changes in the remaining wastewater (112).

The aerated water (120) is then pumped or flows via gravity to a MBR basin (122). The term “MBR” stands for “membrane bioreactor.” The MBR basin (122) holds water as well as one or more submersible membrane unit (SMU), such as SMU (124).

The aerated water (120) flows through the SMU (124). Fine particulates in the aerated water (120) are filtered by pores in the membranes. Thus, filtered water passes through the pores and into the membranes, but the solids remain in the MBR basin (122). The solids may be removed and discarded properly, or pumped or flow via gravity back into the aeration tank (114).

The filtered water that passes through the membrane is known as permeate (128). Water that is ultimately discharged from the water treatment system (100) and approved for recycling is known as treated effluent. Thus, in some cases, the permeate may be considered clean enough for a recycling use and may be deemed treated effluent. However, the permeate (126) may be subject to further treatment in some embodiments before being discharged as treated effluent.

The water treatment system (100) may be considered a system of stages. Together, the buffer tank (104), the screening unit (106) and the pre-treatment tank (108) may be referred to as a pre-treatment stage. Together, the aeration tank (114) and the MBR basin (122), as well as the devices in the aeration tank (114) and the MBR basin (122), may be referred to as a clarifier stage. In different embodiments, each separate system (e.g., the screening unit (106), the pre-treatment tank (108), the aeration tank (114), the MBR basin (122)) may be referred to as a unit process, stage, or a sub-stage. The different unit process may be connected via water channels having one or more baffle plates and/or slide gates (e.g., weir gate, sluice gate, etc.) to control flow between the stages.

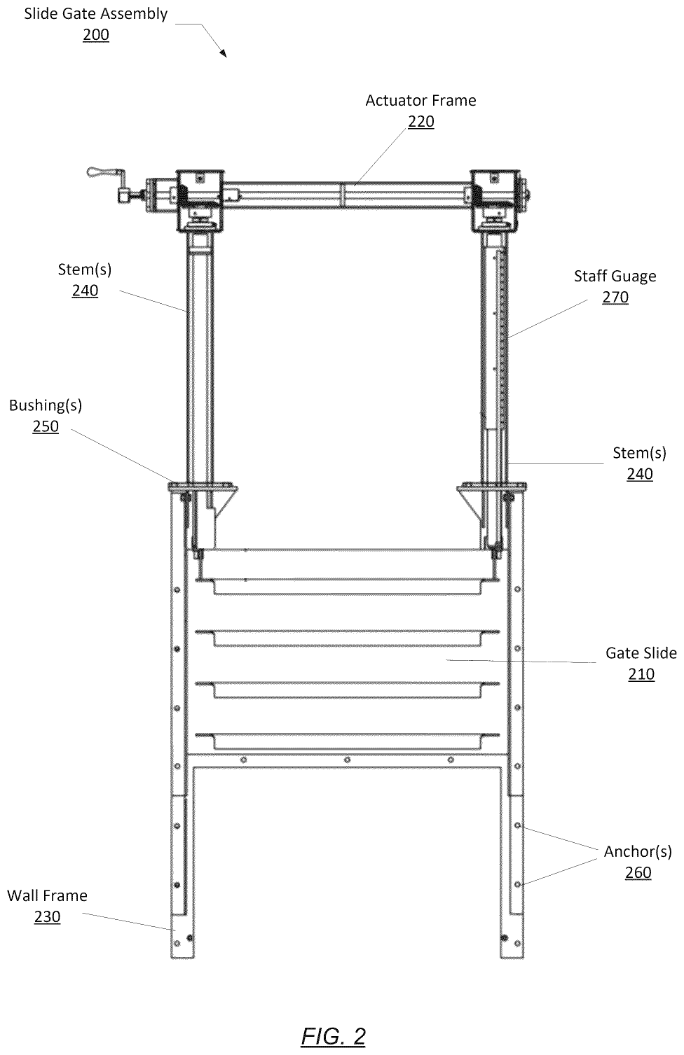

With reference now to FIG. 2, a slide gate assembly is shown according to the illustrative embodiments. The slide gate assembly (200) may be disposed the channels of a wastewater treatment system to control flow between the tanks, such as a buffer tank, a screening unit, a pre-treatment tank, an aeration tank, and a membrane bioreactor basin described in FIG. 1.

The slide gate assembly (200) includes a gate slide (210) positioned within a wall frame (230). The gate slide (210) is aligned to move vertically between an open position and a closed position. The wall frame (230) extends downward to form a support structure that guides and retains the gate slide (210). Anchors (260) are distributed along the vertical members of the wall frame (230) and provide fixed mounting points to secure the wall frame (230) to an external surface.

The gate slide (210) is the main moving component of the slide gate system. It is designed to move vertically to open or close the gate, regulating the flow of water or wastewater. The gate slide is typically made from corrosion-resistant materials like stainless steel to withstand exposure to harsh environmental conditions. Fasteners secure various components of the slide gate assembly. UHMW slide track sections provide a low-friction surface for the gate slide to move along.

The gate slide (210) may operate as a weir gate that controls the flow of wastewater between various stages of a treatment facility. The gate is mounted vertically and features a full-aperture closure, meaning it can completely shut off or throttle the flow through a rectangular or round orifice at the end of a channel or within an in-channel opening. In this configuration, the gate slide moves vertically within the actuator frame to either allow or restrict the flow of wastewater over the top edge of the gate.

The actuator frame (220) spans across the upper portion of the slide gate assembly (200). The actuator frame (220) houses the upper portions of the stems (240) and provides structural support for stem actuation. The actuator frame (220) also maintains spacing and alignment between the stems (240) as they extend upwardly from the gate slide (210).

The actuator frame is a structural component that supports and guides the motion of the slide gate. The actuator frame houses various bushings and bearings to facilitate smooth movement and minimize friction. The frame may be constructed from a strong, durable material such as stainless steel or aluminum to withstand the mechanical forces involved in gate actuation. Wall anchors secure the actuator frame and other structural elements to the surrounding walls or supports. Shaft bushings provide support and reduce friction for the extension shaft, which transfers motion from the actuator to the gate slide.

The wall frame (230) is a structural component that provides support and alignment for the slide gate and associated hardware. This frame is typically made from strong, durable materials such as steel or concrete, designed to withstand the forces exerted by the moving gate and the pressure of the water or wastewater. A track stiffener may be added to increase the rigidity and stability to the gate track, providing strength and resistance to deformation.

A pair of stems (240) are located on opposite lateral sides of the gate slide (210). Each stem (240) extends vertically through bushings (250) mounted to the wall frame (230). The bushings (250) maintain alignment between the stems (240) and the wall frame (230) and permit controlled translation of the stems (240) when actuated. The stems (240) are mechanically coupled to the gate slide (210) to transfer motion and regulate vertical displacement of the gate slide (210) within the wall frame (230).

The bushings (250) are used to reduce friction and wear between moving parts. The bushings are placed at key points where the gate interacts with the actuator frame and other structural elements. The bushings (250) may be UHMW (Ultra-High-Molecular-Weight) bushings are made from a type of polyethylene with a very high molecular weight, providing abrasion resistance and reducing friction.

The dual stem design of the slide gate assembly (200) improves traditional, central-stem designs. In a conventional single-stem weir gate, the centrally mounted stem can become fouled by scum or debris as water flows over the weir. This fouling can interfere with the actuation of the gate, potentially leading to operational issues and necessitating frequent cleaning. By positioning the stems at opposite sides of the gate's periphery, the dual stem design of slide gate assembly (200) eliminates vertical obstructions in the flow path, allowing water and floating debris to pass through or around the gate without accumulating around the stems. In this manner, slide gate assembly (200) significantly reducing the risk of fouling, and improving the overall reliability of the system.

A staff gauge (270) is disposed along one of the stems (240). The staff gauge (270) provides a reference for the position of the gate slide (210) as the stems (240) are actuated. The gauge consists of a graduated scale and an indicator rod that moves in conjunction with the gate, providing a visual representation of the gate's position and helping operators to manage flow rates. Vertical displacement of the gate slide (210) is directly indicated by the staff gauge (270), which allows monitoring of the relative opening of the slide gate assembly (200).

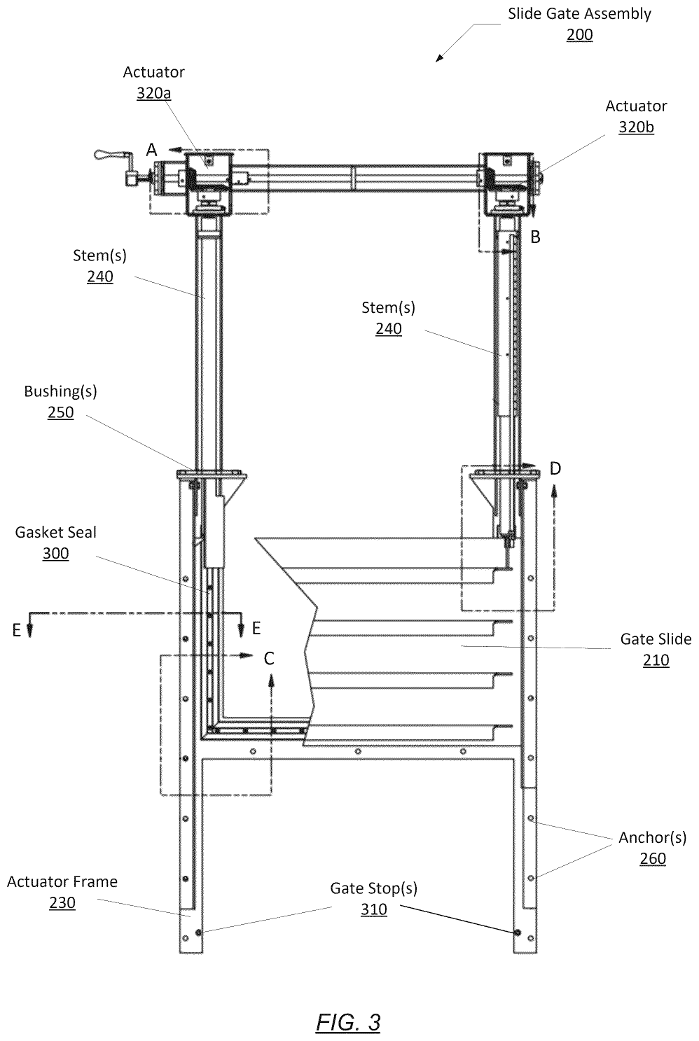

With reference now to FIG. 3, a cutaway view of the slide gate assembly (200) is shown according to the illustrative embodiments. The figure illustrates internal and structural components not visible in the elevation view of FIG. 2.

The gate slide (210) is positioned within the wall frame (230) and remains aligned for vertical movement between open and closed positions. Gate stops (310) are provided along the path of the gate slide (210) to limit its travel and prevent overextension during operation. The gate stops (310) are secured relative to the wall frame (230) and interact with the gate slide (210) to define maximum displacement positions.

A pair of stems (240) extend vertically on opposite sides of the gate slide (210). Each stem (240) is coupled to the actuator frame (220) and passes through bushings (250) for alignment. The bushings (250) maintain smooth translation and limit lateral displacement of the stems (240) as they are actuated. Anchors (260) are disposed on the wall frame (230) to secure the slide gate assembly (200) to an external structure.

Actuators (320a, 320b) are mounted to the actuator frame (220) and mechanically coupled to the stems (240). Each actuator transfers motion to its corresponding stem (240), producing vertical displacement of the gate slide (210). The actuators (320a, 320b) may operate in coordination to provide balanced motion across both stems (240).

A gasket seal (300) is positioned between the gate slide (210) and the wall frame (230). The gasket seal (300) extends along the periphery of the gate slide (210) and provides sealing engagement to reduce leakage when the gate slide (210) is in the closed position. The gasket seal (300) includes a batwing profile, with opposed extensions forming multiple contact points between the gate slide (210) and the wall frame (230).

The gasket seal is a flexible, compressible material used to create a watertight barrier between the gate and the wall frame. This seal may be constructed from rubber or a similar elastomeric material, providing resistance to water and chemicals. The gasket seal is typically mitered at the corners and vulcanized to form a continuous, watertight barrier.

The gasket seal features a batwing design to provide an enhanced sealing surface. The batwing seal features extensions, or “wings,” that create additional contact points with the gate and wall frame, improving the overall seal under varying pressure conditions, preventing leaks, and maintaining the efficiency of the water treatment system.

The batwing gasket features an extended sealing surface, creating additional contact points between the gate slide and the wall frame. This design enhances the gasket's ability to conform to irregularities and maintain a tight seal under varying pressure conditions. In other words, the batwing gasket provides an improved seal that reduces leakage, ensuring that wastewater is effectively contained and directed through the intended flow path within the treatment facility.

The cutaway view illustrates section lines A through E, which correspond to detailed sectional views of the slide gate assembly (200) shown in later figures. These sectional views provide further details of the interaction between the stems (240), the gasket seal (300), and the actuator components.

The batwing gasket features an extended sealing surface, creating additional contact points between the gate slide and the wall frame. This design enhances the gasket's ability to conform to irregularities and maintain a tight seal under varying pressure conditions. In other words, the batwing gasket provides an improved seal that reduces leakage, ensuring that wastewater is effectively contained and directed through the intended flow path within the treatment facility.

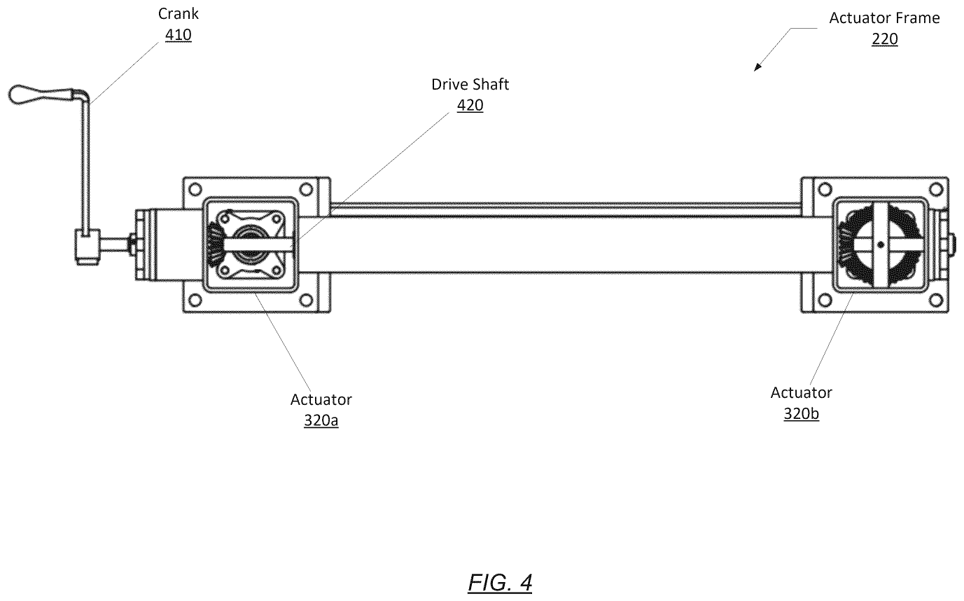

With reference now to FIG. 4, a top view of the actuator frame (220) is shown according to the illustrative embodiments. The figure illustrates the relative arrangement of actuation components mounted to the actuator frame (220).

The actuator frame (220) spans across the upper portion of the slide gate assembly (200) and supports a pair of actuators (320a, 320b). The actuators are mounted on opposing sides of the actuator frame (220) and are configured to transfer motion to the stems (240). Placement of the actuators (320a, 320b) at lateral positions maintains balanced actuation of the gate slide (210).

A crank (410) is mechanically coupled to one of the actuators (320a) and is connected to a drive shaft (420). The crank (410) converts rotary output from the actuator (320a) into rotational motion of the drive shaft (420). The drive shaft (420) extends laterally across the actuator frame (220) and provides mechanical linkage between the actuators (320a, 320b). In this arrangement, actuation forces may be transferred through the drive shaft (420) to coordinate the motion of both stems (240).

The positioning of the crank (410), drive shaft (420), and actuators (320a, 320b) within the actuator frame (220) ensures that vertical displacement of the stems (240) remains synchronized. The top view highlights the integration of the drive shaft (420) into the actuator frame (220) and its role in distributing torque evenly across the dual stem configuration.

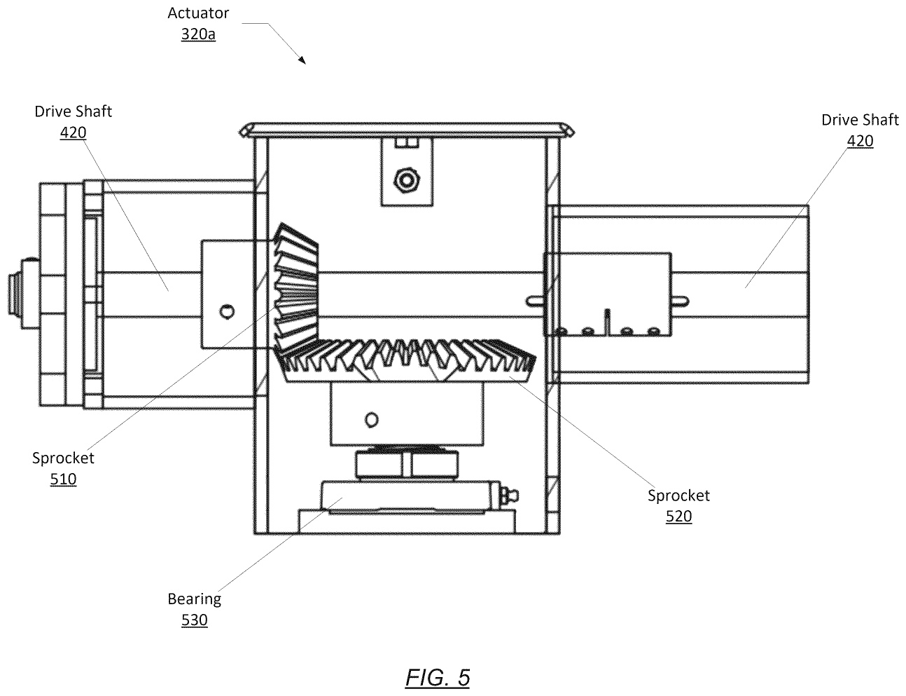

With reference now to FIG. 5, a detail view of actuator (320a) is shown according to the illustrative embodiments. The figure illustrates the mechanical components that interface between actuator (320a) and the stems (240) of the slide gate assembly (200).

Actuator (320a) is mechanically connected to a drive shaft (420). The drive shaft (420) extends laterally and is supported at intervals by bearings (530). The bearings (530) maintain rotational alignment of the drive shaft (420) and reduce friction during operation.

A sprocket (510) is mounted to the drive shaft (420) near actuator (320a). The sprocket (510) is configured to engage with a corresponding sprocket (520) located further along the drive shaft (420). Together, sprockets (510, 520) transmit rotary motion across the drive shaft (420) and distribute actuation force to both sides of the actuator frame (220).

The arrangement of sprockets (510, 520), drive shaft (420), and bearings (530) allows actuator (320a) to transfer torque in a controlled manner. This ensures that motion delivered from actuator (320a) is distributed evenly, maintaining synchronized movement of the dual stems (240) when opening or closing the gate slide (210).

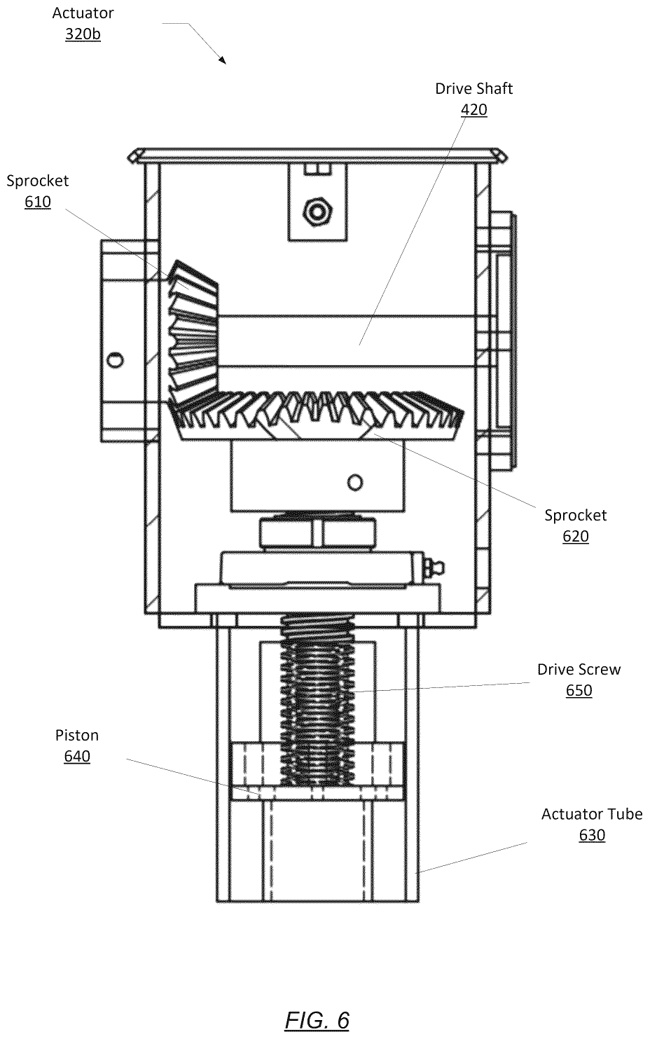

With reference now to FIG. 6, a detail view of actuator (320b) is shown according to the illustrative embodiments. The figure illustrates additional actuation components configured to transfer motion to the stems (240) of the slide gate assembly (200).

Actuator (320b) is connected to a drive shaft (420) that extends laterally across the actuator frame (220). A pair of sprockets (610, 620) are mounted to the drive shaft (420). The sprockets (610, 620) provide rotary engagement with corresponding mechanical components, enabling torque transfer and coordinated actuation of the stems (240).

A drive screw (650) is mechanically linked to the drive shaft (420). The drive screw (650) is aligned within an actuator tube (630) and is configured to convert rotary motion from the drive shaft (420) into linear displacement. A piston (640) is disposed within the actuator tube (630) and is engaged with the drive screw (650). As the drive screw (650) rotates, the piston (640) is displaced linearly within the actuator tube (630), producing controlled vertical motion.

The interaction of actuator (320b), sprockets (610, 620), drive shaft (420), drive screw (650), and piston (640) provide a mechanical linkage that translates rotary input into vertical displacement of the stems (240). This configuration maintains synchronization between actuator (320b) and actuator (320a) during movement of the gate slide (210).

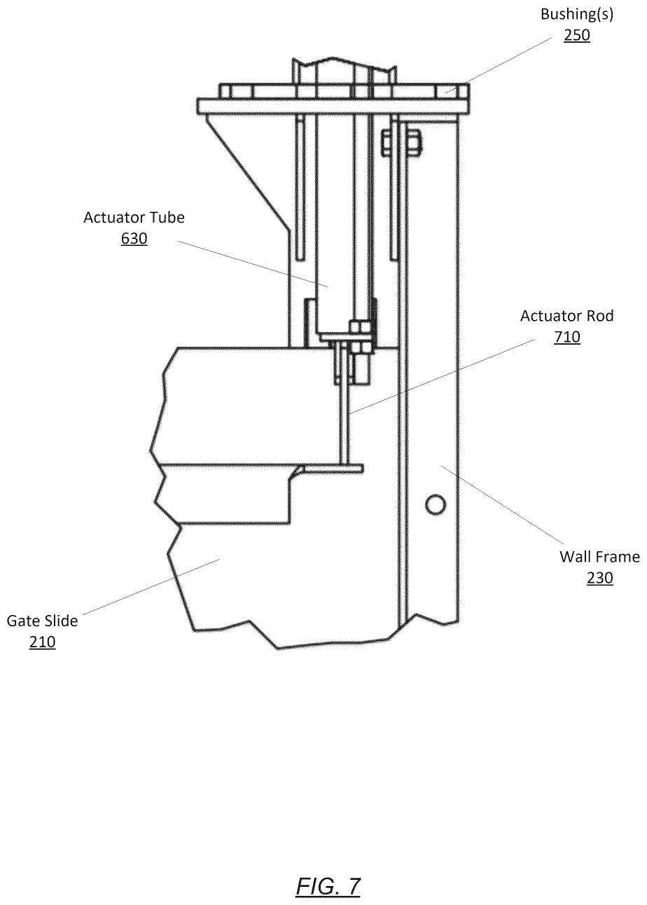

With reference now to FIG. 7, a detail view of the gate slide (210) and actuator rod (710) attachment is shown according to the illustrative embodiments. The figure illustrates the interface between the actuator components and the moving gate slide (210).

The actuator rod (710) extends downward from the actuator tube (630) and is configured to translate linear motion from the piston (640) into vertical displacement of the gate slide (210). The actuator rod (710) is mechanically coupled to the upper portion of the gate slide (210) to provide a direct connection between the actuation mechanism and the moving gate element.

The gate slide (210) remains aligned within the wall frame (230) during displacement. Bushings (250) are disposed along the interface between the actuator rod (710) and the wall frame (230) to maintain alignment and reduce friction during actuation. The arrangement of the actuator rod (710), gate slide (210), wall frame (230), and bushings (250) ensures that linear motion from the actuator system is efficiently transferred into controlled vertical movement of the gate slide (210).

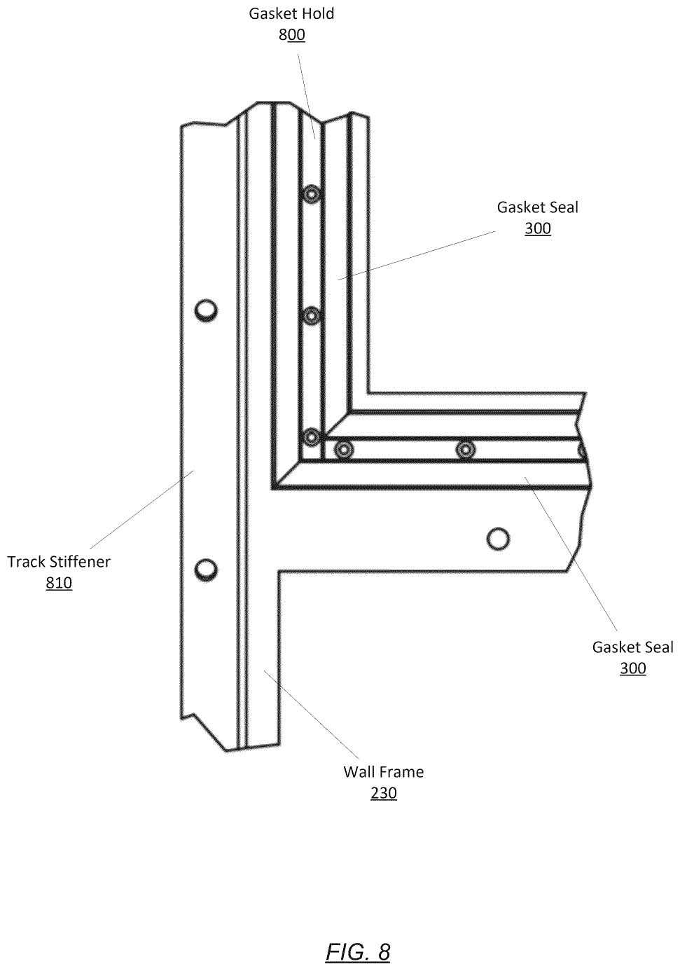

With reference now to FIG. 8, a detail view of the wall frame (230) with attached gasket seal (300) is shown according to the illustrative embodiments. The figure highlights the sealing elements that engage with the gate slide (210) to reduce leakage when the slide gate assembly (200) is in use.

The wall frame (230) provides the mounting surface for the gasket seal (300) along the periphery of the flow opening. The gasket seal (300) is secured against the wall frame (230) so that it is positioned to contact the gate slide (210) during closing. The gasket seal (300) features a batwing profile, in which lateral extensions project outward to form multiple lines of contact against the gate slide (210) and the wall frame (230). These multiple contact points maintain engagement under both seated and unseated head pressure conditions, reducing leakage paths around the gate slide (210).

The gasket seal (300) may be constructed from elastomeric materials such as natural rubber, neoprene, or EPDM (ethylene propylene diene monomer). These materials provide flexibility, resilience, and resistance to water, wastewater, and chemical contaminants present in treatment environments. The compressibility of the elastomer allows the batwing extensions to conform to irregularities in the gate slide (210) and the wall frame (230), ensuring a continuous sealing surface under varying operating pressures.

The batwing profile of the gasket seal (300) is formed with mitered corners that are vulcanized together to produce a continuous, integral sealing barrier. Vulcanization bonds the elastomer segments at the corners, eliminating discontinuities that could otherwise permit leakage. The continuous vulcanized configuration allows the gasket seal (300) to maintain watertight integrity along the entire perimeter of the gate slide (210), including at the junctions where the vertical and horizontal portions meet.

A gasket hold (800) is mounted along the wall frame (230) to retain the gasket seal (300) in position. The gasket hold (800) compresses the base of the gasket seal (300) against the wall frame (230), preventing displacement during gate operation and ensuring long-term sealing performance. The gasket hold (800) may be formed from stainless steel or aluminum and is fastened to the wall frame (230) with bolts or similar hardware.

A track stiffener (810) is positioned adjacent to the gasket seal (300) along the wall frame (230). The track stiffener (810) increases rigidity of the wall frame (230) in the sealing region, reducing deflection under hydraulic pressure and maintaining consistent alignment of the gate slide (210) relative to the gasket seal (300). The combined arrangement of the wall frame (230), gasket seal (300), gasket hold (800), and track stiffener (810) forms a sealing assembly that provides reliable engagement, structural support, and leakage control for the slide gate assembly (200).

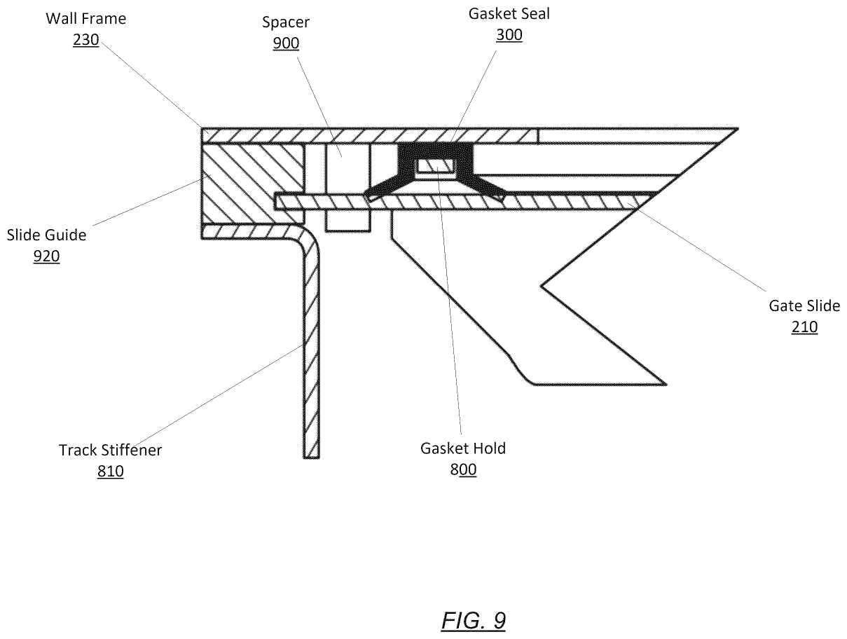

With reference now to FIG. 9, a cross-section view of the wall frame (230) is shown according to the illustrative embodiments. The figure more clearly illustrates the batwing profile of the gasket seal (300) and its relationship with the surrounding structural components.

The gasket seal (300) is mounted along the inner surface of the wall frame (230). In cross-section, the batwing profile of the gasket seal (300) is visible, with lateral extensions projecting outward to form multiple lines of contact. These extensions create redundant sealing points against the gate slide (210) during closure, ensuring that leakage is reduced across a range of pressure conditions. The compressible elastomeric material of the gasket seal (300) allows the batwing extensions to deform against the gate slide (210) when the gate is lowered, producing a tight engagement that conforms to surface irregularities.

The batwing gasket seal (300) extends continuously along the perimeter of the wall frame (230). At corner regions, the gasket seal (300) is formed with mitered joints that are vulcanized to create an uninterrupted sealing interface. The vulcanization process bonds the elastomer segments, preventing separation and eliminating gaps at the corners. This construction helps to ensure that the watertight barrier provided by the gasket seal (300) remains effective around the entire gate opening.

A slide guide (920) is positioned along the inner edge of the wall frame (230) to direct vertical movement of the gate slide (210). The slide guide (920) establishes a controlled channel within which the gate slide (210) is retained, preventing lateral displacement during operation. The slide guide (920) may be formed from ultra-high-molecular-weight polyethylene (UHMW) or other low-friction polymeric materials that provide wear resistance and reduce frictional drag as the gate slide (210) moves. In some embodiments, the slide guide (920) may include replaceable liner sections, allowing for maintenance or replacement without disassembly of the wall frame (230). The slide guide (920) may also be configured with fastening points that secure it directly to the wall frame (230) or to the spacer (900), ensuring rigid support under operating loads.

A spacer (900) is disposed between the slide guide (920) and the wall frame (230) to establish correct positioning and clearance for the gate slide (210). The spacer (900) ensures that the gate slide (210) maintains uniform engagement with the gasket seal (300) along its vertical travel path. The spacer (900) may be constructed from stainless steel, aluminum, or a structural composite material, selected to provide dimensional stability and resistance to corrosion in wastewater environments. The spacer (900) may be machined or fabricated with precision thickness tolerances to maintain consistent alignment between the slide guide (920) and the wall frame (230). In some configurations, the spacer (900) may be segmented to allow independent replacement of worn sections without disturbing adjacent components.

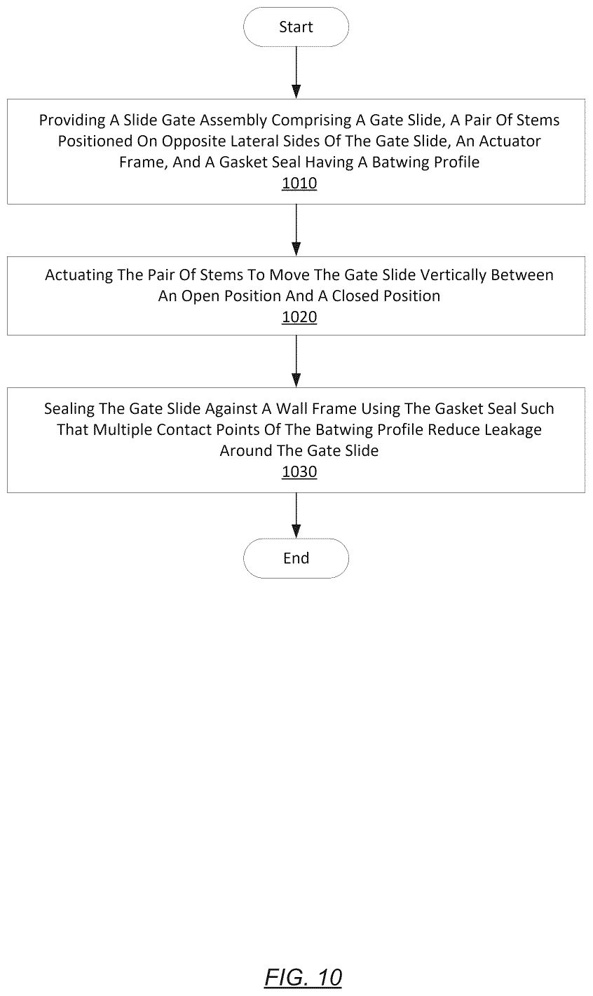

With reference now to FIG. 10, a flowchart of a process for controlling flow of wastewater between treatment stages in a wastewater treatment facility is shown according to the illustrative embodiments. The process is implemented using the slide gate assembly and associated components described above.

At step 1010, the process includes providing a slide gate assembly comprising a gate slide, a pair of stems positioned on opposite lateral sides of the gate slide, an actuator frame, and a gasket seal having a batwing profile. The slide gate assembly is disposed within a wall frame positioned between treatment stages, such as between an aeration tank and a membrane bioreactor basin. The stems are mechanically coupled to the gate slide through actuator rods, while the actuator frame houses actuators that transmit motion to the stems. The gasket seal, retained by a gasket hold and reinforced by a track stiffener, is mounted along the wall frame to form a sealing interface with the gate slide.

At step 1020, the pair of stems are actuated to move the gate slide vertically between an open position and a closed position. Motion may be imparted through actuators mounted to the actuator frame, which drive the stems through cranks, drive shafts, sprockets, and drive screws. Linear motion from the actuators is transmitted to pistons within actuator tubes, which displace actuator rods coupled to the gate slide. This configuration provides synchronized movement of the stems and balanced vertical displacement of the gate slide. Movement of the gate slide regulates flow of wastewater through the channel formed by the wall frame.

At step 1030, the gate slide is sealed against the wall frame using the gasket seal. The batwing profile of the gasket seal forms multiple contact points between the gate slide and the wall frame, reducing leakage around the perimeter of the gate slide. The gasket seal includes mitered corners vulcanized together to form a continuous sealing barrier. As the gate slide moves into the closed position, the batwing extensions of the gasket seal compress against the surface of the gate slide, conforming to irregularities and maintaining contact under varying hydraulic pressure. The slide guide and spacer align the gate slide with the gasket seal during this process, ensuring that the sealing engagement is consistent throughout the range of operation.

The process may further include monitoring the position of the gate slide using a staff gauge mounted along one of the stems. The staff gauge provides a visual reference of the displacement of the gate slide and allows an operator to determine the extent of flow permitted through the channel. By following the steps of providing the slide gate assembly, actuating the stems, and sealing the gate slide against the wall frame, the flow of wastewater between treatment stages is controlled in a manner consistent with the claimed method.

While the various steps in this flowchart are presented and described sequentially, at least some of the steps may be executed in different orders, may be combined or omitted, and some of the steps may be performed in parallel. Furthermore, the steps may be performed actively or passively.

Operation of the slide gate as a weir gate within a water treatment facility is enhanced by the dual stem design and the batwing gasket. The dual stem design prevents fouling by eliminating vertical obstructions in the flow path, while the batwing gasket provides a superior seal, reducing leakage. These improvements result in more reliable operation, reduced maintenance requirements, and greater efficiency in controlling the flow of wastewater between treatment stages.

The term “about,” when used with respect to a physical property that may be measured, refers to an engineering tolerance expected by or determined by one ordinary skill in the art. The exact quantified degree of an engineering tolerance depends on the product being produced, the process being performed, or the technical property being measured. For a non-limiting example, two angles may be “about congruent” if the values of the two angles are within ten percent of each other. However, if the ordinary artisan determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product and thus is capable of assessing how to determine the variance of measurement contemplated by the term “about.”

As used herein, the term “connected to” contemplates at least two meanings. In a first meaning, unless otherwise stated, “connected to” means that component A could have been separate from component B, but is joined to component B in either a fixed or a removably attached arrangement. In a second meaning, unless otherwise stated, “connected to” means that component A is integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such, includes the term “and.” Further, items joined by the term “or” may include any combination of the items with any number of each item, unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A slide gate assembly comprising:
a gate slide configured to move vertically between an open position and a closed position relative to a flow channel;
a pair of stems coupled to opposite lateral sides of the gate slide, each stem extending vertically and configured to actuate the gate slide;
an actuator frame supporting the stems and guiding movement of the gate slide; and
a gasket seal mounted between the gate slide and a wall frame, the gasket seal comprising a batwing profile having opposed extensions configured to form multiple contact points with the gate slide and the wall frame to reduce leakage.

2. The slide gate assembly of claim 1, wherein the stems are threaded stems configured to translate rotary motion from actuators into linear displacement of the gate slide.

3. The slide gate assembly of claim 1, wherein the actuator frame comprises:
ultra-high-molecular-weight polyethylene (UHMW) bushings positioned to reduce friction between the stems and the actuator frame.

4. The slide gate assembly of claim 1, wherein the gasket seal is retained by a gasket hold bar secured to the wall frame.

5. The slide gate assembly of claim 1, wherein the batwing profile of the gasket seal further comprises:
mitered corners, wherein the mitered corners are vulcanized to form a continuous watertight barrier.

6. The slide gate assembly of claim 1, wherein the gate slide further comprises:
a stainless-steel construction that is guided within UHMW slide track sections.

7. The slide gate assembly of claim 1, wherein the actuator frame further comprises:
a staff gauge and indicator rod configured to provide a visual indication of the position of the gate slide.

8. The slide gate assembly of claim 1, wherein the wall frame further comprises:
a track stiffener configured to increase rigidity of the slide gate assembly.

9. A wastewater treatment facility comprising:
a buffer tank, a screening unit, a pre-treatment tank, an aeration tank, and a membrane bioreactor basin connected by channels; and
at least one slide gate assembly according to claim 1 disposed in at least one of the channels, the slide gate assembly configured to control flow between the tanks,
wherein the pair of stems are positioned laterally to avoid vertical obstructions in a flow path through the gate, and the gasket seal with batwing profile reduces leakage around the gate slide.

10. The wastewater treatment facility of claim 9, wherein the slide gate assembly is disposed between the aeration tank and the membrane bioreactor basin.

11. The wastewater treatment facility of claim 9, further comprising:
a pair of electric actuators mounted to the actuator frame, wherein the pair of electric actuators actuate the pair of stems.

12. The wastewater treatment facility of claim 9, wherein the channels further comprise:
a baffle plate positioned upstream of the slide gate assembly to regulate inflow conditions.

13. The wastewater treatment facility of claim 9, wherein the batwing profile of the gasket seal maintains contact with the gate slide under both seated and unseated head pressure conditions.

14. The wastewater treatment facility of claim 9, wherein the actuator frame is anchored to a concrete structure forming the wall frame of the channel.

15. The wastewater treatment facility of claim 9, wherein the membrane bioreactor basin further comprises:
at least one submersible membrane unit that receives flow regulated by the slide gate assembly.

16. The wastewater treatment facility of claim 9, wherein the stems are positioned at opposite peripheral sides of the gate slide to minimize fouling from floating debris.

17. A method of controlling flow of wastewater between treatment stages in a wastewater treatment facility, the method comprising:
providing a slide gate assembly comprising a gate slide, a pair of stems positioned on opposite lateral sides of the gate slide, an actuator frame, and a gasket seal having a batwing profile;
actuating the pair of stems to move the gate slide vertically between an open position and a closed position; and
sealing the gate slide against a wall frame using the gasket seal such that multiple contact points of the batwing profile reduce leakage around the gate slide.

18. The method of claim 17, further comprising:
maintaining a flow path free of vertical obstructions between treatment stages by positioning the pair of stems at lateral peripheries of the gate slide.

19. The method of claim 17, further comprising:
reducing friction during actuation by providing UHMW bushings between the stems and the actuator frame.

20. The method of claim 17, further comprising:
visually monitoring a position of the gate slide using a staff gauge and indicator rod coupled to the actuator frame.

21. The method of claim 17, further comprising:
guiding the gate slide along UHMW slide track sections.

22. The method of claim 17, wherein actuating the pair of stems further comprises:
rotating the stems using manual handwheels or motor-driven actuators.

23. The method of claim 17, further comprising:
directing wastewater through an aeration tank and into a membrane bioreactor basin using the slide gate assembly.

24. The method of claim 17, further comprising:
compressing the batwing profile of the gasket seal against the wall frame to conform to irregularities and maintain a watertight barrier.
